(19) United States
(12) Patent Application Publication
(10) Pub. No.: US 2019/0101190 A1
(43) Pub. Date: Apr. 4, 2019

(54) DOUBLE HELICAL GEAR AND METHOD OF WELDING DOUBLE HELICAL GEAR

(71) Applicant: TOYOTA JIDOSHA KABUSHIKI KAISHA, Toyota-shi (JP)

(72) Inventor: Tadashi TAKAGAKI, Toyota-shi (JP)

(73) Assignee: TOYOTA JIDOSHA KABUSHIKI KAISHA, Toyota-shi (JP)

(21) Appl. No.: 16/059,245

(22) Filed: Aug. 9, 2018

(30) Foreign Application Priority Data
Oct. 3, 2017 (JP) 2017-193739

(51) Int. Cl. F16H 1/08; F16H 55/17

(52) U.S. Cl. CPC F16H 1/08; F16H 55/08; F16H 55/17

(57) ABSTRACT

A double helical gear includes a rotating shaft, a first gear, a second gear, a first weld zone, and a second weld zone. The first gear and the second gear are disposed side by side in an axial direction on the rotating shaft, the first gear includes a first teeth part, the second gear includes a second teeth part, and the first gear includes a first annular part to be fitted to the rotating shaft. The first weld zone is located on the first end surface, and has a welded part extending over a fitting portion between the first annular part and the rotating shaft as the first end surface is seen from the axial direction. The second weld zone is located on the second end surface of the first annular part at a gap between the first teeth part and the second teeth part in the axial direction.

### INCORPORATION BY REFERENCE

The disclosure of Japanese Patent Application No. 2017-193739 filed on Oct. 3, 2017 including the specification, drawings and abstract is incorporated herein by reference in its entirety.

### BACKGROUND

### 1. Technical Field

The present disclosure relates to a double helical gear and a method of welding a double helical gear.

### 2. Description of Related Art

Using a double helical gear for a transmission of a vehicle is disclosed in Japanese Unexamined Patent Application Publication No. 2017-009115 (JP 2017-009115 A). The double helical gear is of an assembly type, and has a structure in which two helical gears are molded separately from a rotating shaft, respectively, and an inner peripheral part of each helical gear is fixed to a flange part of the rotating shaft.

As methods of fixing a gear to a rotating shaft, mechanical fastening (for example, Japanese Unexamined Patent Application Publication No. 2009-216176 (JP 2009-216176 A)) using fastening elements and joining (for example, Japanese Unexamined Patent Application Publication No. 10-231918 (JP 10-231918 A)) by welding are known. JP 2009-216176 A discloses that, with respect to an assembled type double helical gear, one helical gear has a structure in which teeth are integrally molded at a portion of the outer periphery the rotating shaft, and the other helical gear is fastened to the rotating shaft with a pin and a nut. Welding a fitting portion between an inner peripheral part of the gear and the flange part from both sides in an axial direction is disclosed in JP 10-231918 A.

### SUMMARY

However, in a fastening structure described in JP 2009-216176 A, by providing the pin and the nut, an increase in the number of parts and an increase in weight are caused, and the volume in the axial direction is also be increased. Moreover, in a welding method described in JP 10-231918 A, welding is possible solely in a case where an interference member is not present on both axial sides of the gear. In addition, in the structure in which the gear is fixed by the welding, since a tensile residual stress generated in a weld zone acts on the gear, there is a possibility that the gear may be deformed under the influence of the tensile residual stress and tooth surface accuracy may decrease.

The present disclosure provides a double helical gear and a method of welding a double helical gear that can further suppress an increase in weight and an increase in volume due to a fixing structure and can further suppress a decrease in tooth surface accuracy caused by welding.

A first aspect of the present disclosure relates to a double helical gear including a rotating shaft, a first gear, a second gear, a first weld zone, and a second weld zone. The first gear and the second gear are disposed side by side in an axial direction on the rotating shaft. The first gear includes a first teeth part at an outer peripheral part of the first gear, the second gear includes a second teeth part at an outer peripheral part of the second gear, the first teeth part of the first gear and the second teeth part of the second gear are inclined in mutually opposite directions with respect to the axial direction, the first gear includes a first annular part to be fitted to the rotating shaft at an inner peripheral part of the first gear, the first annular part includes two end surfaces of a first end surface and a second end surface in the axial direction, and the second end surface is closer to the second gear than the first end surface is. The first weld zone is located on the first end surface, and has a welded part extending over a fitting portion between the inner peripheral part of the first annular part and the rotating shaft as the first end surface is seen from the axial direction. The second weld zone is located on the second end surface of the first annular part at a gap between the first teeth part of the first gear and the second teeth part of the second gear in the axial direction.

In the double helical gear according to the first aspect of the present disclosure, the double helical gear may further include a third weld zone. The second gear may include a second annular part to be fitted to the rotating shaft at an inner peripheral part of the second gear, the second annular part may include two end surfaces of a third end surface and a fourth end surface in the axial direction, and the fourth end surface may be closer to the first gear than the third end surface is. The third weld zone may be located on the third end surface, and may have a welded part extending over a fitting portion between the inner peripheral part of the second annular part and the rotating shaft as the third end surface is seen from the axial direction. The second weld zone may be located on a mating surface between the fourth end surface of the second annular part and the second end surface of the first annular part, and may have a welded part extending over a radial outer end surface of the first annular part and a radial outer end surface of the second annular part.

According to the first aspect of the present disclosure, weld zones are formed on both axial end sides of each gear even in a case where both the first gear and the second gear are welded to the rotating shaft. From the above description, since tensile residual stresses of the weld zones may act on the both axial sides of each gear, a decrease in tooth surface accuracy caused by welding is further suppressed.

In the double helical gear according to the first aspect of the present disclosure, a surface of the welded part of the first weld zone may be a flat surface formed on the same plane as an axial end surface of the first annular part.

According to the first aspect of the present disclosure, since the surface of the first weld zone is the flat surface, the tensile residual stresses generated in the weld zones can be reduced as compared to a case where the surface of the first weld zone is raised.

A second aspect of the present disclosure relates to a method of welding a double helical gear. The double helical gear includes a rotating shaft, a first gear, and a second gear, the first gear and the second gear are disposed side by side in an axial direction on the rotating shaft, the first gear includes a first teeth part at an outer peripheral part of the first gear, the second gear includes a second teeth part at an outer peripheral part of the second gear, the first teeth part of the first gear and the second teeth part of the second gear are inclined in mutually opposite directions with respect to the axial direction, the first gear includes a first annular part to be fitted to the rotating shaft at an inner peripheral part of the first gear, the first annular part includes two end surfaces of a first end surface and a second end surface in the axial direction, and the second end surface is closer to the second gear than the first end surface is. The method includes forming a first weld zone on the first end surface by welding of the first end surface of the first annular part from the axial direction, and forming a second weld zone that is located on the second end surface of the first annular part at a gap between the first teeth part of the first gear and the second teeth part of the second gear in the axial direction by welding the rotating shaft from a radially outer side. The first weld zone has a welded part extending over a fitting portion between the inner peripheral part of the first annular part and the rotating shaft as the first end surface is seen from the axial direction.

According to the aspect of the present disclosure, by having the first weld zone formed by the welding from the axial direction and the second weld zone formed by the welding from the radially outer side between the two gears that constitute the double helical gear, the weld zones are formed on both axial end sides of each gear welded to the rotating shaft. For that reason, the tensile residual stresses generated in the weld zones balances on both axial sides, and a decrease in the tooth surface accuracy is further suppressed. Since the rotating shaft and the gear are welded, fastening elements become unnecessary, and a lightweight and small-sized double helical gear can be realized.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a sectional view schematically illustrating a double helical gear of a first embodiment;

FIG. 2 is a view for illustrating a welding method in the first embodiment;

FIG. 3 is a view for illustrating the structure of a modification example;

FIG. 4 is a view for illustrating deformation of the gear by welding;

FIG. 5 is a view for illustrating the structure of another modification example;

FIG. 6 is a sectional view schematically illustrating a double helical gear of a second embodiment; and

FIG. 7 is a view for illustrating a welding method in the second embodiment.

### DETAILED DESCRIPTION OF EMBODIMENTS

Hereinafter, double helical gears in embodiments of the present disclosure will be specifically described with reference to the drawings.

### First Embodiment

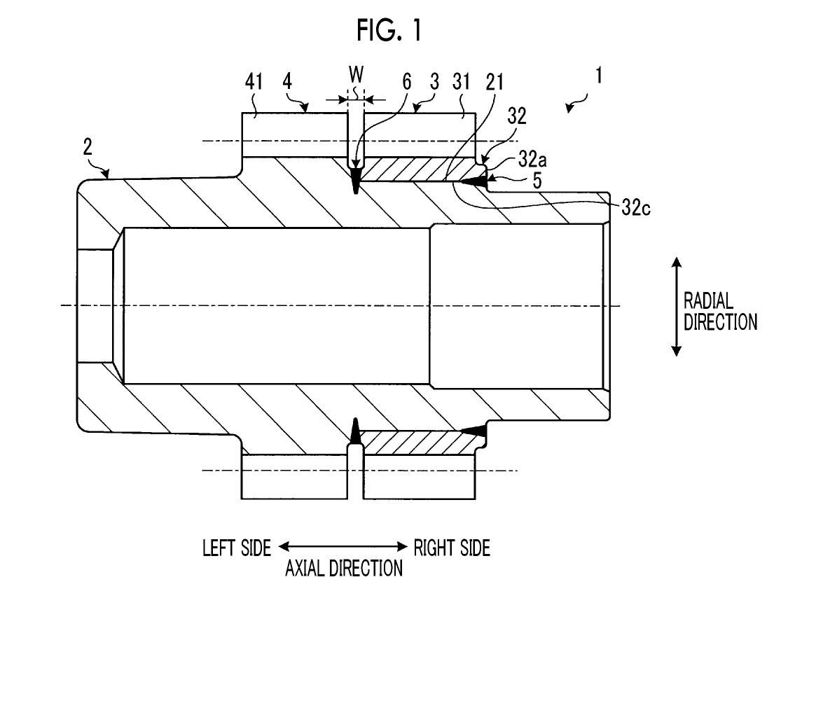

FIG. 1 is a sectional view schematically illustrating a double helical gear 1 of a first embodiment. The double helical gear 1 is an assembled type gear, and is disposed such that one helical gear 3 that is a first gear separately molded from a rotating shaft 2, and the other helical gear 4 that is a second gear integrally molded with the rotating shaft 2 are aligned in an axial direction. The one helical gear 3 is integrated with the rotating shaft 2 by welding. In the above description, an axial right side and an axial left side that are illustrated in FIG. 1 are used for axial positions. The two helical gears 3, 4 aligned in the axial direction are expressed as right and left gears.

One helical gear (hereinafter referred to as a “right gear”) 3 is welded on both sides in the axial direction and is integrated with the rotating shaft 2. The right gear 3 has a teeth part 31 that is inclined with respect to the axial direction, and a hollow annular part 32 that is fitted to an outer peripheral part 21 of the rotating shaft 2. The teeth part 31 is integrally molded with an outer peripheral part of the annular part 32. The annular part 32 is a part welded to the rotating shaft 2.

The other helical gear (hereinafter referred to as a “left gear”) 4 has a teeth part 41 that is inclined with respect to the axial direction. The teeth part 41 is integrally molded with the rotating shaft 2. The teeth part 41 of the left gear 4 and the teeth part 31 of the right gear 3 are inclined in mutually opposite directions. The teeth part 41 and the teeth part 31 are disposed apart from each other in the axial direction, and a predetermined axial gap W is provided between the left teeth part 41 and the right teeth part 31. For example, the axial gap W is set to about several millimeters.

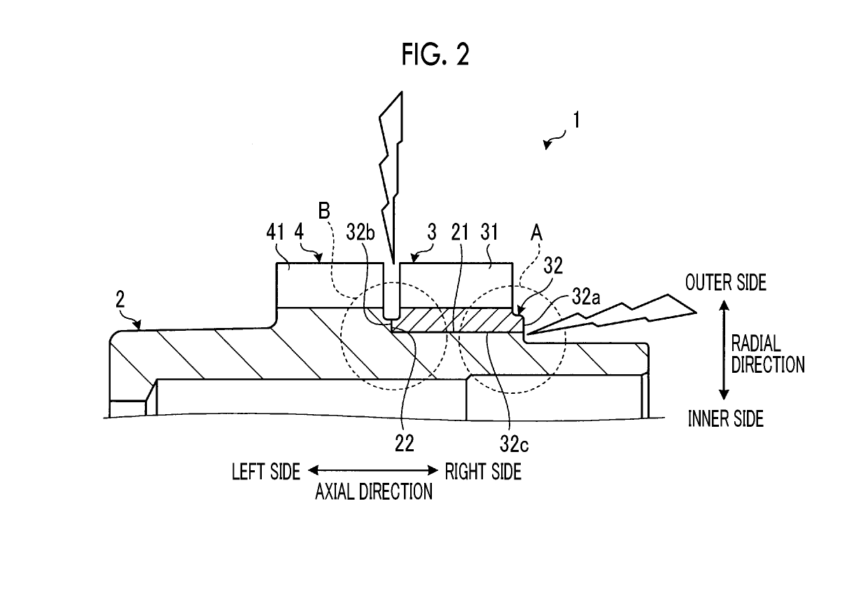

Weld zones in which both axial sides of the annular part 32 are welded to the rotating shaft 2 are formed in the double helical gear 1. As illustrated in black in FIG. 1, the double helical gear 1 has a first weld zone 5 formed on one end surface (hereinafter referred to as a “right end surface”) 32a out of axial end surfaces of the annular part 32, and a second weld zone 6 that is an inter-gear weld zone formed at the axial gap W on the other end surface (hereinafter referred to as a “left end surface”) 32b side out of the axial end surfaces of the annular part 32. The first weld zone 5 has a first welding mark formed by welding from the axial direction. Meanwhile, the second weld zone 6 has a second welding mark formed by welding from a radially outer side. A method of welding the double helical gear of FIG. 1 will be described with reference to FIG. 2.

FIG. 2 is a view for illustrating the welding method in the first embodiment. As illustrated in FIG. 2, welding is performed in a state where the annular part 32 of the right gear 3 is fitted to the rotating shaft 2. For example, the annular part 32 having a cylindrical inner peripheral part 32c may be fitted to the outer peripheral part 21 of the rotating shaft 2, or the annular part 32 having a spline-shaped inner peripheral part 32c may be spline-fitted to the rotating shaft 2.

As illustrated by dashed line circle A in FIG. 2, on the right end surface 32a side of the annular part 32, a portion in which the inner peripheral part 32c of the annular part 32 and the outer peripheral part 21 of the rotating shaft 2 are fitted to each other is welded from the axial right side (one side). Since a member that interferes at the time of welding is not present on the axial right side of the right end surface 32a, it is possible to weld the right end surface 32a side toward the axial left side from the axial right side. From the above description, the first weld zone 5 (first welding mark) is formed. For example, the welding is performed on the entire circumference in a circumferential direction, and the first weld zone 5 is formed over the entire circumference in the circumferential direction on the right end surface 32a side. It is desirable that the first weld zone 5 is formed by laser welding or electron beam welding.

As illustrated by dashed line circle B illustrated in FIG. 2, on the left end surface 32b side of the annular part 32, a mating surface between a stepped part 22 of the rotating shaft 2 and an axial end part of the right gear 3 (a mating surface between the stepped part 22 and the annular part 32) are welded to each other from the radially outer side. Specifically, the mating surface between the stepped part 22 and the annular part 32 is located at the axial gap W between the teeth part 41 of the left gear 4 and the teeth part 31 of the right gear 3. The second weld zone 6 (second welding mark) is formed by performing welding toward the mating surface from the radially outer side of the axial gap W. It is desirable that the second weld zone 6 is formed by laser welding or electron beam welding. According to the laser welding or the electron beam welding, even in a case where the axial gap W between the teeth part 31 of the right gear 3 and the teeth part 41 of the left gear 4 is narrow (for example, gap in units of millimeters), it is possible to weld the left end surface 32b side of the annular part 32 from the radially outer side. For example, the welding is performed on the entire circumference in the circumferential direction, and the second weld zone 6 is formed over the entire circumference in the circumferential direction in the axial gap W.

As described above, according to the first embodiment, both axial sides of the right gear 3 molded separately from the rotating shaft 2 can be welded by forming the second weld zone 6 welded from the radially outer side to the axial gap W between the teeth part 31 of the right gear 3 and the teeth part 41 of the left gear 4. From the above description, since the tensile residual stresses of the individual weld zone 5, 6 act from the both axial sides of the right gear 3 to the right gear 3 equally, deformation of the right gear 3 by welding can be further suppressed. As a result, since a decrease in the tooth surface accuracy of the right gear 3 can be further suppressed, and an error from an involute curve can be made small during rotation in the case of an involute gear, vibration and noise in meshing parts can be further reduced. In addition, one-side abutment of a tooth surface resulting from deformation of the individual weld zone 5, 6 can be further suppressed, and the strength of the double helical gear 1 is further improved.

Since a method of fixing the right gear 3 and the rotating shaft 2 is welding, the double helical gear 1 that is more lightweight and smaller-sized in the axial direction than in a case where the right gear and the rotating shaft are mechanically fixed using fastening elements can be realized. Since the fastening elements are not needed, it is also possible to further suppress an increase in the number of parts.

Since the right gear 3 is welded to the left gear 4 by the second weld zone 6 between the right and left gears, it is possible to further suppress a situation in which the spacing between the right gear 3 and the left gear 4 increases in the axial direction due to a thrust force generated at the time of meshing of the double helical gear 1. From the above description, axial displacement of the right gear 3 due to the thrust force can be further suppressed. As a result, since the one-side abutment of the right and left gear teeth can be further suppressed, the vibration and the noise in the meshing parts can be further reduced, and the strength of the double helical gear 1 is further improved.

The right gear 3 and the left gear 4 may have the same phase or may have shifted phases. In addition, the double helical gear 1 of the first embodiment is not limited to the above-described structure. For example, the first weld zone 5 and the second weld zone 6 are not limited to being formed on the entire circumference in the circumferential direction, and may be partially formed in the circumferential direction. It is desirable that an interference fit or an intermediate fit is performed at a fitting portion between the annular part 32 is welded to the rotating shaft 2.

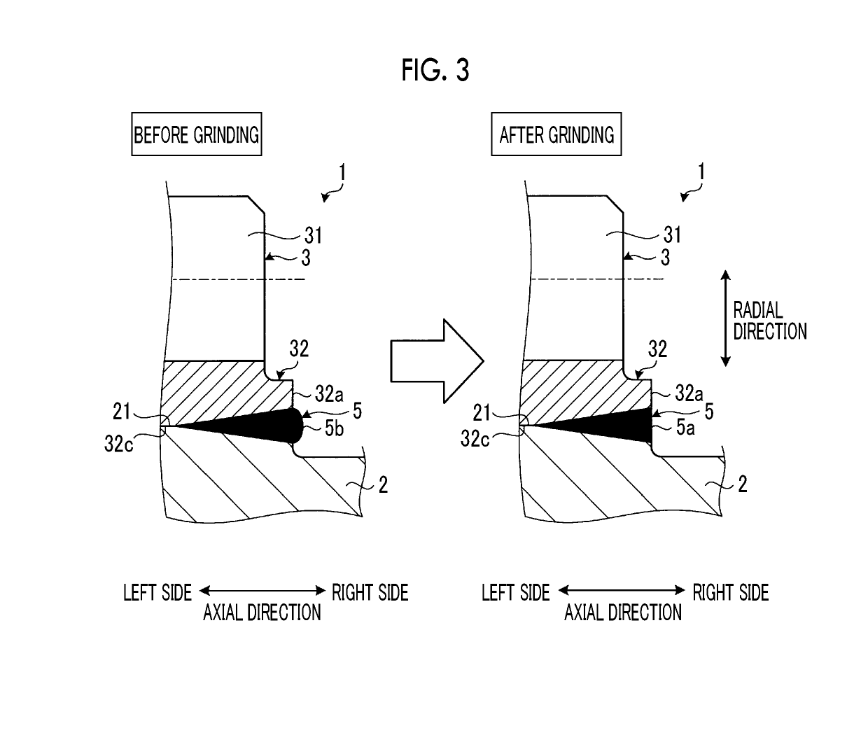

Beads of the weld zones formed when the annular part 32 is welded to the rotating shaft 2 may be flattened by grinding. From the above description, the tensile residual stresses of the weld zones are further reduced, and joining strength is further improved. For example, as illustrated in FIG. 3, in a case where a bead surface 5b of the first weld zone 5 is grinded, the bead surface 5b of the first weld zone 5 is brought into a state where the bead surface 5b is swelled further to the right in the axial direction than the right end surface 32a before the grinding. However, by grinding the bead surface 5b in a flat shape along the right end surface 32a, a surface 5a of the first weld zone 5 becomes a flat surface formed on the same plane as the right end surface 32a after the grinding. In addition, as the surface 5a of the first weld zone 5 becomes the flat surface, the right end surface 32a and the surface 5a become axial end surfaces (receiving surfaces) when a bearing is press-fitted. From the above description, it is not necessary to separately machine a stepped part for receiving an inner ring end surface of the bearing in the rotating shaft 2.

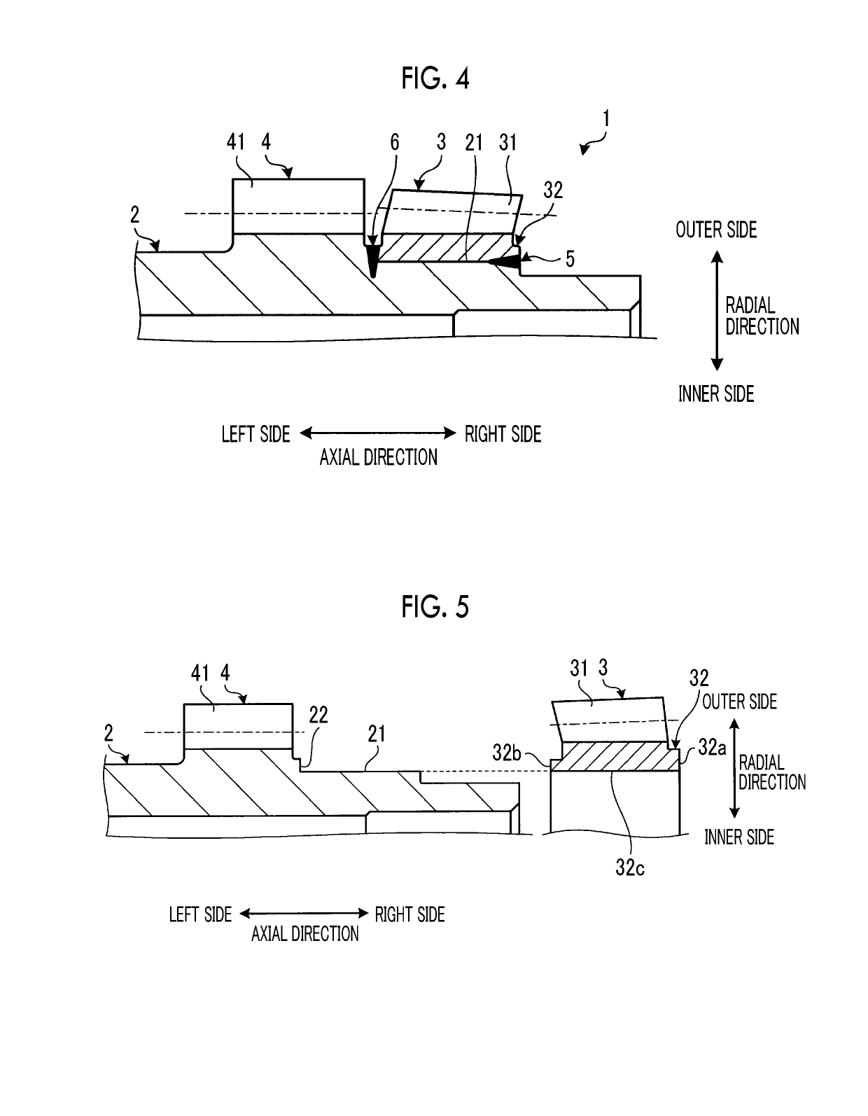

As a modification example of the first embodiment, the teeth part 31 of the right gear 3 to be welded to the rotating shaft 2 may have a shape in a direction opposite to a deformation direction in advance before assembling due to distortion (tensile residual stresses) generated in the individual weld zone 5, 6. As illustrated in FIG. 4, there is a case where the right gear 3 after welding may be deformed so as to be inclined with respect to the axial direction due to the tensile residual stresses generated in the individual weld zone 5, 6. In this case, since the tensile residual stress of the first weld zone 5 is larger than the tensile residual stress of the second weld zone 6, the pitch circle diameter of the right gear 3 becomes gradually smaller toward the first weld zone 5 side (axial right side) from the second weld zone 6 side (axial left side) in the axial direction. In anticipation of the above deformation, as illustrated in FIG. 5, the right gear 3 before welding (before assembling) may have a shape that is distorted in advance in the direction (the pitch circle diameter becomes gradually larger toward the axial right side from the axial left side) opposite to the above-described deformation direction.

### Second Embodiment

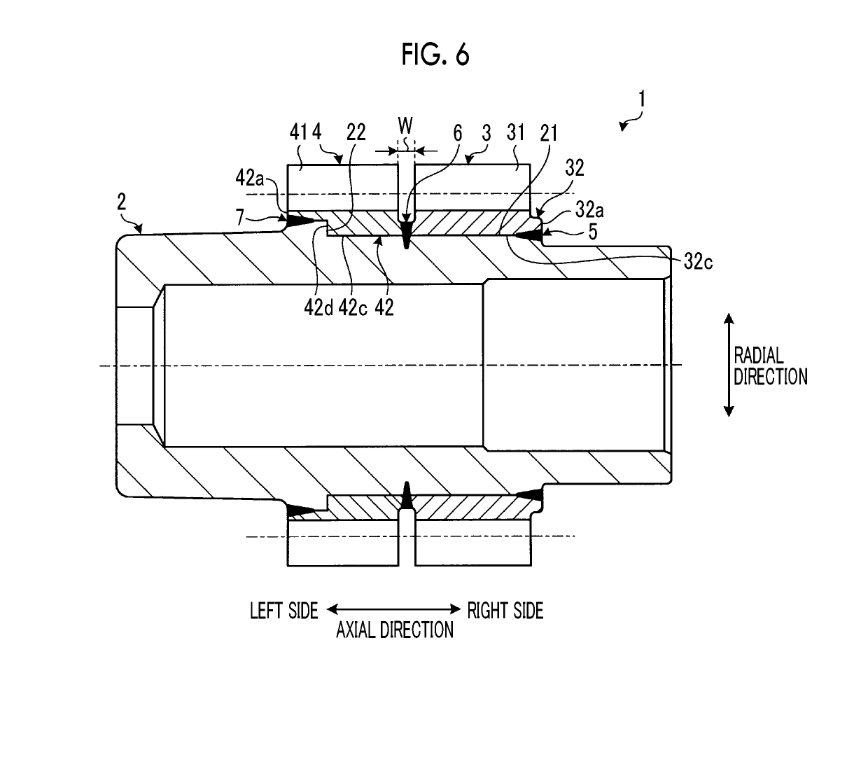

FIG. 6 is a sectional view schematically illustrating a double helical gear 1 of a second embodiment. In the double helical gear 1 of the second embodiment, both the right gear 3 and the left gear 4 are molded separately from the rotating shaft 2, and the right gear 3 and the left gear 4 are integrated with the rotating shaft 2 by welding. In description of the second embodiment, the description of the same components as those of the first embodiment will be omitted, and the reference signs of the components will be cited.

As illustrated in FIG. 6, the left gear 4 has the teeth part 41 integrally molded at an outer peripheral part thereof, and has an annular part 42 to be fitted to the rotating shaft 2 at an inner peripheral part thereof. The annular part 42 is a part to be welded to the rotating shaft 2 on both end axial sides.

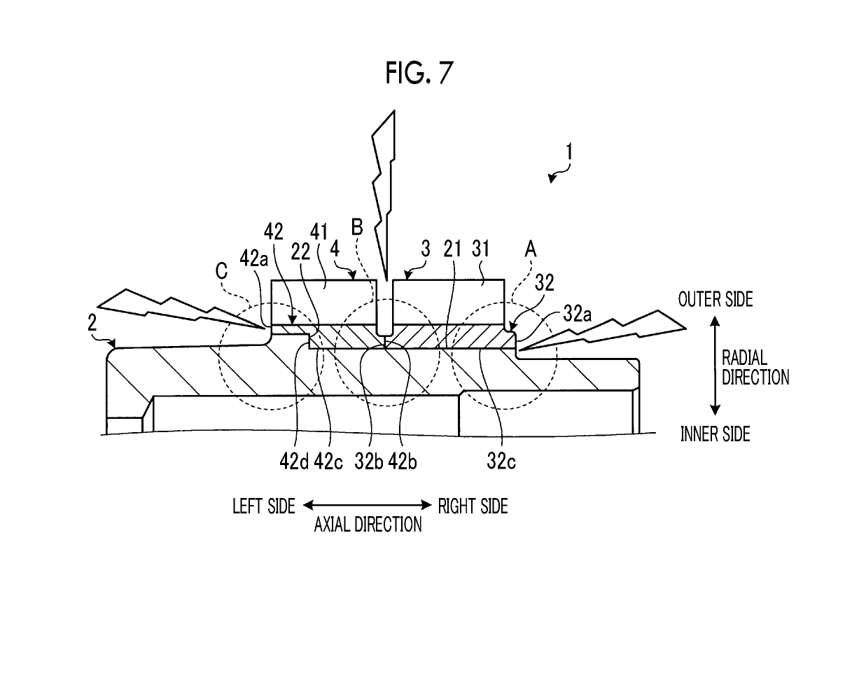

The second weld zone 6 (inter-gear weld zone) formed by welding from the radially outer side and a third weld zone 7 formed by welding from the axial direction are formed on both axial end sides of the annular part 42. The third weld zone 7 is formed on the other end surface (hereinafter referred to as a “left end surface”) 42a on a side opposite to the right gear 3 out of the axial end surfaces of the annular part 42. As illustrated in FIG. 7, the second weld zone 6 is formed by welding a mating surface of an end surface (hereinafter referred to as a “right end surface”) 42b on the right gear 3 side out of the axial end surfaces of the annular part 42 and the left end surface 32b of the annular part 32 from the radially outer side. A method of welding the double helical gear of FIG. 6 will be described with reference to FIG. 7.

FIG. 7 is a view for illustrating the welding method in the second embodiment. As illustrated in FIG. 7, welding is performed in a state where the annular part 42 of the left gear 4 and the annular part 32 of the right gear 3 are fitted to the rotating shaft 2. For example, the annular part 42 having a cylindrical inner peripheral part 42c may be fitted to the outer peripheral part 21 of the rotating shaft 2, or the annular part 42 having a spline-shaped inner peripheral part 42c may be spline-fitted to the rotating shaft 2.

As illustrated by dashed line circle C in FIG. 7, on the left end surface 42a side of the annular part 42, a fitting portion between the inner peripheral part 42c of the annular part 42 and the rotating shaft 2 is welded from the axial left side. A positioning part 42d that abuts against the stepped part 22 of the rotating shaft 2 at the time of fitting (before welding) is provided on the left end side of the inner peripheral part 42c. Since a member that interferes at the time of welding is not present on the axial left side of the left end surface 42a, it is possible to weld the left end surface 42a side toward the axial right side from the axial left side. From the above description, the third weld zone 7 (third welding mark) is formed. For example, the welding is performed on the entire circumference in a circumferential direction, and the third weld zone 7 is formed over the entire circumference in the circumferential direction on the left end surface 42a side. It is desirable that the third weld zone 7 is formed by laser welding or electron beam welding.

As illustrated by dashed line circle B, on the right end surface 42b side of the annular part 42, in order to form the inter-gear weld zone in FIG. 7, a portion in which the left gear 4 and the right gear 3 abut against each other in the axial direction (a mating surface between the axial end surface of the annular part 42 and the axial end surface of the annular part 32) is welded from the radially outer side. Specifically, an axial position of the mating surface between the left annular part 42 and the right annular part 32 is located at the axial gap W.

As described above, according to the second embodiment, even in a case where both the right and left gears 3, 4 are molded separately from the rotating shaft 2, it is possible to weld both axial end sides of each of the gears 3, 4. From the above description, similar to the first embodiment, a lightweight and small-sized gear can be formed, and a decrease in tooth surface accuracy can be further suppressed.

A bead surface of the third weld zone 7 may be grinded, and the third weld zone 7 having a flat surface formed on the same plane as the left end surface 42a may be formed.

What is claimed is:

1. A double helical gear comprising:
a rotating shaft;
a first gear and a second gear that are disposed side by side in an axial direction on the rotating shaft, the first gear including a first teeth part at an outer peripheral part of the first gear, the second gear including a second teeth part at an outer peripheral part of the second gear, the first teeth part of the first gear and the second teeth part of the second gear being inclined in mutually opposite directions with respect to the axial direction, the first gear including a first annular part to be fitted to the rotating shaft at an inner peripheral part of the first gear, the first annular part including two end surfaces of a first end surface and a second end surface in the axial direction, and the second end surface being closer to the second gear than the first end surface is;
a first weld zone that is located on the first end surface, the first weld zone having a welded part extending over a fitting portion between the inner peripheral part of the first annular part and the rotating shaft as the first end surface is seen from the axial direction; and
a second weld zone that is located on the second end surface of the first annular part at a gap between the first teeth part of the first gear and the second teeth part of the second gear in the axial direction.

2. The double helical gear according to claim 1, further comprising a third weld zone, wherein:
the second gear includes a second annular part to be fitted to the rotating shaft at an inner peripheral part of the second gear;
the second annular part includes two end surfaces of a third end surface and a fourth end surface in the axial direction;
the fourth end surface is closer to the first gear than the third end surface is;
the third weld zone is located on the third end surface, and has a welded part extending over a fitting portion between the inner peripheral part of the second annular part and the rotating shaft as the third end surface is seen from the axial direction; and
the second weld zone is located on a mating surface between the fourth end surface of the second annular part and the second end surface of the first annular part, and has a welded part extending over a radial outer end surface of the first annular part and a radial outer end surface of the second annular part.

3. The double helical gear according to claim 1, wherein a surface of the welded part of the first weld zone is a flat surface formed on the same plane as an axial end surface of the first annular part.

4. A method of welding a double helical gear including a rotating shaft, a first gear, and a second gear, the first gear and the second gear being disposed side by side in an axial direction on the rotating shaft, the first gear including a first teeth part at an outer peripheral part of the first gear, the second gear including a second teeth part at an outer peripheral part of the second gear, the first teeth part of the first gear and the second teeth part of the second gear being inclined in mutually opposite directions with respect to the axial direction, the first gear including a first annular part to be fitted to the rotating shaft at an inner peripheral part of the first gear, the first annular part including two end surfaces of a first end surface and a second end surface in the axial direction, and the second end surface being closer to the second gear than the first end surface is, the method comprising:
forming a first weld zone on the first end surface by welding of the first end surface of the first annular part from the axial direction, the first weld zone having a welded part extending over a fitting portion between the inner peripheral part of the first annular part and the rotating shaft as the first end surface is seen from the axial direction; and
forming a second weld zone that is located on the second end surface of the first annular part at a gap between the first teeth part of the first gear and the second teeth part of the second gear in the axial direction by welding the rotating shaft from a radially outer side.
